(19) United States
(12) Patent Application Publication
(10) Pub. No.: US 2008/0264548 A1
(43) Pub. Date: Oct. 30, 2008

(54) Optical distortion removal

(76) Inventor: Jian-Zhi Jay Zhang, Ithaca, NY (US)

Correspondence Address: CORNING INCORPORATED, SP-TI-3-1, CORNING, NY, 14831, US

(21) Appl. No.: 11/605,879

(22) Filed: Nov. 28, 2006

(51) Int. Cl. B32B 27/36; B32B 17/06; B32B 27/30

(52) U.S. Cl. 156/99; 428/141; 428/426; 428/332; 428/412; 428/500; 428/480; 428/522; 428/192

(57) ABSTRACT

The present invention describes an article that is substantially free of optical distortion and a method for eliminating or substantially reducing the need for conventional polishing of transparent objects. The article comprises a laminate of an optically distorting transparent object bonded with an adhesive to at least one transparent object that has a distortion-free surface. The indices of refraction of the adhesive and the objects are preferably within 0.2. The method includes adhesively bonding an optically distorting transparent object to one or more transparent objects having distortion-free surfaces so that the distortion-free surface is exposed.

### FIELD OF THE INVENTION

The invention relates to an article and method for removing optical distortions caused by surface imperfections in transparent materials, particularly specialty glass sheets.

### BACKGROUND OF THE INVENTION

Glass has many useful properties, of which optical transparency is one of the more important. Although transparent, surface irregularities in the glass may result in optical distortions. Irregularities may be formed, for example, during manufacture, in use or service, or as a result of damage. Surface irregularities include surface roughness, waviness or ripples, cut or saw marks, point defects, scratches, etc. The method of manufacture of the glass significantly affects surface irregularities and ultimately optical properties.

Glass, glass-ceramics, and ceramics, hereinafter collectively glass, may be formed by batch processes, such as blown, pressed and cast, or continuous processes, such as rolled, fusion and float. Manufactures tend to favor continuous processes for their cost savings and efficiency. Of the continuous methods, fusion and float processes are able to produce flat glass sheet with a surface that is substantially free of surface irregularities and, therefore, optical distortion. The float process is also inexpensive and has come to dominate the market for distortion-free glass sheet.

The float process pulls molten glass from a furnace over a bath of molten tin. As the glass cools and hardens, the side facing the tin bath remains flat. The float process can produce a superior, flat glass sheet with few optical distortions. Surface roughness can be less than 0.1 μm RMS, which is sufficient for most sheet glass applications. Unfortunately, not all glasses are amenable to the float process. Viscosities, chemical compositions, and thicknesses of the glass are all limiting factors. For example, the float process has difficulty with thicknesses greater than 25 mm. The fusion process can accommodate thicker glasses; however, the cost increases substantially and only higher viscosity glass compositions are suitable for fusion.

Rolling is a more flexible continuous process than either the float or fusion processes, and may be used with a wider variety of compositions, viscosities, and thicknesses. The roll process pulls glass from a furnace and through a plurality of rollers. The rollers impart irregularities on the glass surface. Irregularities include roughness and waviness, and manifest as optical distortions. Roughness of a rolled product typically exceeds 0.1 μm RMS and may approach 1 mm RMS. Roughness often produces haziness associated with diffuse reflection from the surface. Waviness, that is, the distance between peaks and valleys on the surface of the rolled glass, results in gross optical distortions. Float glass, which is produced on a quiescent liquid tin bath, has very low roughness and essentially no waviness. The waviness of a rolled product may have a periodicity of up to 1 cm and amplitude of at least 0.1 mm and up to 0.2-0.4 mm. Such large surface irregularities produce significant optical distortion.

The rolled glass process is often used for thick glass sheet, which may be used in armor or projectile-resistant applications. Such glasses can be several inches thick. Unfortunately, thicker glass requires higher roll pressure so larger irregularities appear on the glass surface. Optical distortion increases and the surface must be ground and polished to achieve good optical clarity and flatness. Of course, thicker glasses having low optical distortion may be produced using the cast or fusion processes, but the cost of glasses produced in this manner is often not commercially viable.

Grinding and polishing, hereinafter polishing, of rolled glasses adds to the time and cost of producing a glass that is free of optical distortion. Polishing can include simple grinding of the surface with abrasives, such as alumina or cerium oxide. Polishing may also include more exotic techniques, such as laser heating which locally melts and levels the glass. In either case, the glass surface is leveled to remove sources of optical distortion. Polishing costs approximately $15 per square foot for typical glasses starting with a surface roughness of about 10 μm RMS. By comparison, optical quality float glass can be made for less than $1 per square foot depending on thickness and composition. The fusion process can produce optical quality glass for about $3-5 per square foot.

Economics often relegates the roll process to specialty glasses because of thickness, composition, quantity, etc. The roll process is often used to produce thick, hard glasses that cannot easily be manufactured by any other method. Harder glasses are more difficult to polish. Thicker glass results in larger irregularities to be polished. Both factors increase polishing costs. Additionally, polishing often removes material from the glass and can thereby reduce the glass' mechanical integrity.

Prior art includes laminated glasses, which comprise a sandwich of two or more sheets of glass or plastic, bonded together by a flexible, substantially transparent adhesive. The laminate may include any type of glass. The transparent adhesive may include urethanes, which are a family of polymers usually formed by the reaction of a diisocyanate with a hydroxyl, polyvinyl butyral also known as PVB, epoxies, and even liquid crystals, which hold the sheets together by capillary action. The glass itself retains its original breaking properties but, if the laminated glass is cracked or broken, the flexible material may hold the glass fragments in place.

Prior art also includes resins and methods of fixing a surface chip or crack in glasses, especially laminated glasses for use in windshields and the like. The crack or chip impairs the transparency of the glass and can create an optical distortion. A liquid resin is injected into a crack in the glass. The resin may be a two-part product comprising a base resin and an initiator or a one-part resin that is initiated with radiation. The hardened resin bonds to the glass and has a refractive index similar enough to the glass that it is essentially invisible. Care must be taken to level the resin with the surface of the glass; otherwise, optical distortion, such as lensing, may occur.

A need exists for article and method of quickly yet inexpensively removing optical distortion from transparent objects. The article and method should be less expensive and more rapid than polishing. The article and method should not reduce the strength of the object and, preferably, would even increase the object's toughness and fracture resistance. The article and method should find utility with various transparent objects, such as glass and plastic.

### SUMMARY OF THE INVENTION

The present invention describes an article and method that reduces optical distortion in transparent materials, where the optical distortion is caused by surface irregularities. The method can eliminate the need for polishing, can increase the strength of the article, and is both inexpensive and rapid.

In a broad aspect, the article comprises an adhesive between a first transparent object and a second transparent object. The first transparent object includes an optically distorting surface that produces unacceptable optical distortion. The second transparent object includes at least one substantially optically distortion-free surface. The second transparent object is laminated to the textured surface with the adhesive so that the distortion-free surface defines an outer surface. The indices of refraction of the adhesive and the objects are preferably within 0.2.

The first object may comprise a material possessing the desired bulk properties of the article but including an optically distorting surface that produces optical distortion. The second object may comprise an inexpensive material with at least one surface substantially free of optical distortion. The second object may be extremely thin relative to the first object. The second object is laminated with the adhesive to the optically distorting surface so that the distortion-free surface defines an outer surface.

In one embodiment, the article includes a first object comprising a rolled glass product. Such products may have thicknesses of more than 7 cm. The rolled glass product includes two optically distorting surfaces. The second object consists essentially of two float glass sheets having a thickness of less than 1 mm. A PVB adhesive secures one float glass sheet to each optically distorting surface. The article is essentially free of a visible optical distortion. Polishing of the rolled glass product is eliminated.

In another embodiment, the article includes a plurality of first objects having optically distorting surfaces and at least two second objects having a substantially distortion-free surface. The second objects sandwich the first objects so that the distortion-free surface defines the outer surfaces. An index-matched adhesive bonds the objects. The resultant article essentially free of a visible optical distortion, and polishing is avoided.

The method includes providing a first transparent object having at least one irregular surface that produces unacceptable optical distortion. A second transparent object includes at least one surface that is substantially free of optical distortion. The second object is laminated to the first object with an adhesive so that the distortion-free surface is exposed. The adhesive and objects are preferably selected so that they possess sufficiently-matching indices of refraction to avoid parallax effects.

### BRIEF DESCRIPTION OF THE DRAWINGS

FIG. 1 is a cross-section of one embodiment of the invention.

FIG. 2 is a cross-section of a second embodiment of the invention.

FIG. 3 is a cross-section of a third embodiment of the invention.

### DETAILED DESCRIPTION OF THE DRAWINGS

The present invention describes a laminated article that is substantially free of optical distortion and a method for eliminating or substantially reducing the need for conventional polishing of transparent objects. The invention reduces or eliminates polishing, so the article loses little or no material during the process. As used in this application, “transparent” and “distortion-free” mean sufficiently optically clear and free of optical distortion, respectively, for the intended end use. All transparent objects contain some level of optical distortion, including blurriness, diffuse reflection, lensing, and other aberrations. Distortion may be determined either objectively, for example, by light scattering instrumentation, or subjectively by the observer. The degree of transparency and the acceptability of an optical distortion will depend on various factors, including the application and the scrutiny of the observer. For example, an article that is sufficiently transparent and free of optical distortion for use as a cooktop may be inadequate as a window glass.

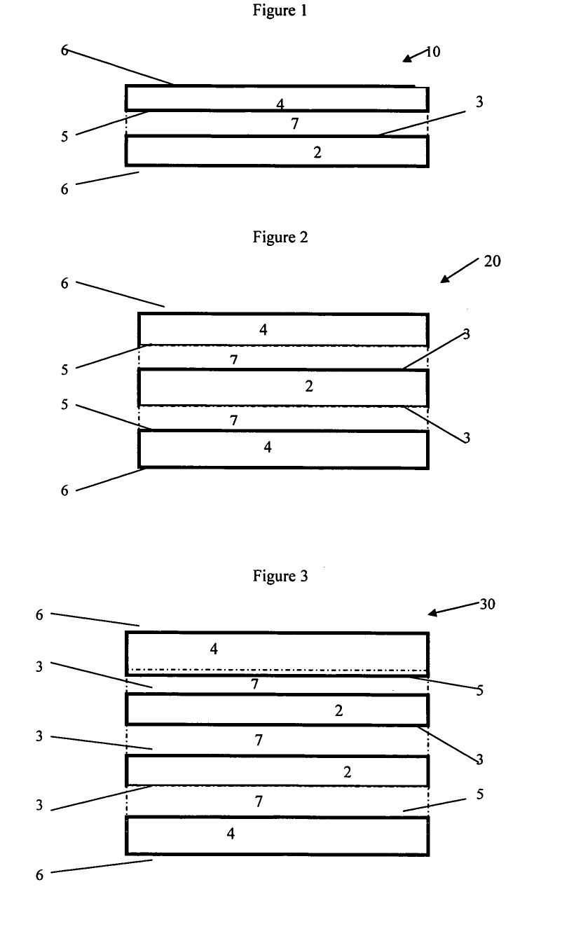

With reference to the FIGS. 1-3 illustrating the invention, the outer surfaces of the articles 10, 20 and 30 are always numbered as 6 and the transparent adhesive layer is always numeral 7. Surface 6 in a final article is always a distortion-free surface. Surface 3 is always an inner surface of the article, is in contact with an adhesive, and is a textured surface having surface imperfections that result in unacceptable optical distortion. Surface 5 is always an inner surface, that is, a surface in contact with an adhesive, and may be either a distortion-free surface or a textured surface having surface imperfections that result in unacceptable optical distortion.

With reference to FIG. 1, in which two articles are laminated, the article 10 includes a first transparent object 2 having an optically distorting, or textured, surface 3. The textured surface 3 includes surface imperfections that result in unacceptable optical distortion. A second transparent object 4 includes an inner surface 5 and an outer surface 6. At least the outer surface 6 will have a substantially optically distortion-free surface. A transparent adhesive 7 bonds the inner surface 5 of the second object 4 with the textured surface 3 of the first object 2. Consequently, surface scattering from the textured surface 3 and the inner surface 5 does not occur and optical distortion of the laminated article 1 is reduced. The second transparent object and the adhesive should have indices of refraction sufficiently similar to the first object that distortion between layers or parallax is not a problem. The indices of refraction should be within about 0.2 and preferably will be within 0.1. (Note that in the final article 10 of FIG. 1 as illustrated, first transparent object 2 has one surface 6, an outer surface, that is distortion-free. In other embodiments as exemplified in FIGS. 2 and 3, object 2 can have two surfaces 3 that include surface imperfections that result in unacceptable optical distortion.)

FIG. 2 shows a second embodiment of the invention comprising an article 20 with a plurality of laminates. The first transparent object 2 includes two textured surfaces 3. A transparent adhesive 7 bonds the inner surface 5 of the second transparent object 4 to each textured surface 3 of the first object 2. The article 20, therefore, presents only the distortion-free outer surfaces 6 to the surroundings.

FIG. 3 shows another embodiment of the invention comprising an article 30 having two first objects 2. The first objects 2 may each have one or more textured surfaces 3. A transparent adhesive 7 bonds the inner objects 2. The inner objects 2 are sandwiched by second objects 4 having at least one distortion-free outer surface 6. In any of the embodiments, the inner surface 5 may or may not be free of optical distortion. The article 30, therefore, presents only the distortion-free outer surfaces 6 to the surroundings.

The transparent objects comprise any transparent material, including glass, glass-ceramic, or polymeric materials. The composition of the transparent objects is largely irrelevant so long as the objects are suitable for their intended application. For example, the objects may comprise a tempered or untempered, silica-soda glass. Alternatively, the object may comprise a glass-ceramic such as transparent beta-quartz glass, such as described in U.S. Pat. No. 4,018,612 which is hereby incorporated by reference. Plastics may include any convenient transparent polymer, particularly those capable of being formed into a sheet, such as acrylic, polycarbonate, polyethylenterephthalate, or polystyrene.

The objects may be of any shape so long as the textured surface of the first object bonds to the inner surface of the second object. Obviously, the shape of the article, whether curved or varying in thickness, can affect its optical distortion. The invention may be used to produce non-planar articles with distortion-free surfaces. Flat articles, such as produced by laminates of sheet goods, will reduce distortion caused the shape of the article. A flat article may include objects of nearly any shape so long as the outer surfaces are flat. The inner surfaces of objects may be curved, wavy, hazy, or otherwise optically distorting so long as when the object presents an outer surface in the final article as illustrated as article 10, 20 of 30, the outer surfaces of the final article are flat.

Generally, the first object will define the bulk properties of the article, and the second object will simply provide a distortion-free outer surface. For example, in transparent armor applications, the first object may be several inches thick. The second object may be very thin and have a thickness of less than 1 mm. The second object may even comprise a sacrificial surface. The second object may be replaced upon the occurrence of an optically distorting event, such as breakage, scratching, etc.

The transparent adhesive should be fluid enough to fill the surface irregularities of the textured surface. The adhesive will also provide sufficient adhesion between the two objects. Adhesion may include chemical bonding, mechanical bonding, or even capillary action. Where optical distortions are cause by micron-sized irregularities, the adhesive as applied may initially have a low viscosity so as to penetrate into the small crevices. A more viscous adhesive may be used and may be preferable for macroscopic irregularities, such as waviness. Obviously, the adhesive may solidify by processes such as curing (UV, thermal or other), drying, or cooling. Alternatively, the adhesive may remain a fluid provided relative translation of the objects is limited by, for example, a frame around the objects or pins through the objects. Adhesive, in this context, means a fluid in combination with a mechanical fastener that prevents translational motion. Generally, capillary forces are sufficient to retain a liquid adhesive between the objects. The mechanical fastener may include a sealer that restricts loss of the liquid adhesive. An example of such a mechanical fastener includes, without limitation, a frame around the perimeter of the article. For example, the article fits into a groove in the frame and a sealant or gasket in the groove prevents loss of the adhesive.

The objects and the adhesive should have similar indices of refraction. The differences in refractive index should be no more than 0.2 and preferably less than 0.1. For example, glass-bonding adhesives that possess such an index of refraction include PVB and certain urethanes and epoxies. The latter two may be obtained as initially low viscosity fluids that cure to a solid. This makes them very useful for filling small surface irregularities. One skilled in the art would appreciate the various other chemicals could also be used as an adhesive for transparent objects.

The transparent objects may be laminated by any convenient method. Glass laminates may be produced using a standard autoclave process. Glass laminate manufacturers already laminate glass sheets and glass sheet with polymeric sheets. For example, a laminate comprising glass sheet and polycarbonate sheet forms a transparent armor. Polyurethane and PVB are the typical laminating adhesives for armor applications. Transparent armor must defeat armor piercing projectiles, so a thick panel of a hard glass-ceramic is often used. Bonding a thin float glass sheet to the hard glass-ceramic can avoid polishing of the glass-ceramic.

The method of the invention includes adhesively bonding a first transparent object to a second transparent object. The first object includes at least one irregular or textured surface that produces unacceptable optical distortion. The second object includes at least one surface that is substantially free of optical distortion. The second object is bonded to the first object with an adhesive so that the distortion-free surface is defines the outer surface. The adhesive and objects are preferably selected so that they possess sufficiently matching indices of refraction. A plurality of first objects may be bonded before the distortion-free second object is bonded to form the outer surface. Another distortion-free object may be bonded to the other surface of the first objects, thereby forming a laminate of first objects sandwiched between distortion-free second objects.

### EXAMPLE 1

A first object consisted of a sheet of glass having an optically distorting surface. Viewing a scene through the first object resulted in unacceptable blurriness. A thin film of water was spread over the optically distorting surface. A second object of optical quality sheet glass was placed over the optically distorting surface. A frame around the objects held the first and second objects together. Capillary action held the water between the glass sheets during the experiment. The index of refraction of the glass and water was 1.5 and 1.33, respectively. Unacceptable blurriness was eliminated.

### EXAMPLE 2

Transparent armor for use as windows in armored vehicles may comprise multiple layers of float glass laminated together by an autoclave process. Each layer of float glass has a distortion-free surface. The transparent armor comprises a laminate of multiple layers of float glass. The armor may be more than four inches thick and weigh more than 50 pounds per square foot. Glass-ceramic windows with similar armor properties are typically more than thirty percent lighter. Float or fusion processes do not lend themselves to producing a thick, glass-ceramic sheet, so a transparent glass-ceramic sheet is produced by the rolled glass process. Prior art glass-ceramic windows required expensive, time-consuming polishing that ground away material and weakened the glass-ceramic.

A glass-ceramic sheet was produced by the rolled glass process. The rollers were polished to a nominally smooth finish, but the resulting glass-ceramic sheet had visibly textured surfaces and unacceptable optical distortion for window applications. Texture included surface roughness as measured in μm and larger deformations, that is, waviness, as measured in millimeters. Instead of polishing the glass-ceramic sheet, a thin (0.5-0.7 mm) sheet of distortion-free glass sheet was laminated to the textured surfaces using a PVB adhesive. The thin glass sheets added essentially no weight to the article while maintaining the strength-to-weight benefits of glass-ceramic. The laminated article had superior optical properties and no discernable optical distortion.

Obviously, numerous modifications and variations of the present invention are possible. It is, therefore, to be understood that within the scope of the following claims, the invention may be practiced otherwise than as specifically described. While this invention has been described with respect to certain preferred embodiments, different variations, modifications, and additions to the invention will become evident to persons of ordinary skill in the art. All such modifications, variations, and additions are intended to be encompassed within the scope of this patent, which is limited only by the claims appended hereto.

What is claimed:

1. A transparent laminate article comprising:
(a) a first transparent object including at least one optically distorting surface;
(b) a second transparent object including at least one substantially optically distortion-free surface and an inner surface; and
(c) a transparent adhesive bonding the optically distorting surface and the inner surface, whereby the distortion-free surface defines an outer surface.

2. The transparent laminate article of claim 1, wherein the adhesive and the first and second objects have indices of refraction within 0.2.

3. The transparent laminate article of claim 1, wherein optically distorting surface has a roughness of greater than 0.1 μm RMS.

4. The transparent laminate article of claim 1, wherein optically distorting surface has a waviness with amplitude of greater than 0.1 mm.

5. The transparent laminate article of claim 1, wherein the distortion-free surface has a roughness of less than 0.1 μm RMS.

6. The transparent laminate article of claim 1, wherein the first transparent object comprises rolled glass.

7. The transparent laminate article of claim 1, wherein the first transparent object comprises a glass-ceramic.

8. The transparent laminate article of claim 1, wherein the first transparent object has a thickness of greater than 25 mm.

9. The transparent laminate article of claim 1, wherein the second transparent object is selected from the group consisting of float glass, fused glass, and plastic.

10. The transparent laminate article of claim 7, wherein plastic is selected form a group consisting of acrylic, polycarbonate, polyethylenterephthalate, and polystyrene.

11. The transparent laminate article of claim 1, wherein the adhesive is selected from a group consisting of polyurethane, PVB, and epoxies.

12. The transparent laminate article of claim 1, wherein a mechanical fastener secures the first object to the second object and the adhesive comprises an index-matched fluid, where the adhesive and the first and second objects have indices of refraction within 0.2.

13. The transparent laminate article of claim 12, wherein the article includes a perimeter, and the mechanical fastener is a frame at least partially surrounding the perimeter.

14. A method of producing an optically distortion-free surface over a transparent object having an optically distorting surface, the method comprising:
(a) providing a first transparent object comprising at least one optically distorting surface;
(b) providing a second transparent object comprising at least one distortion-free surface and an inner surface; and
(c) bonding the inner surface to the optically distorting surface using an adhesive, whereby the distortion-free surface defines an outer surface.

15. The method of claim 14, wherein the first transparent object includes a plurality of optically distorting surfaces and a plurality of second transparent objects are bonded so that the distortion-free surfaces defines the outer surfaces.

16. The method of claim 15, wherein the method includes laminating a plurality of first transparent objects together before bonding with the second objects.

17. A transparent laminate article comprising;
a first transparent object including at least one optically distorting surface;
a second transparent object including at least one substantially optically distortion-free surface and an inner surface, the second transparent object selected from a group consisting of float glass, fused glass, and plastic; and
a transparent adhesive bonding the optically distorting surface and the inner surface, whereby the distortion-free surface defines an outer surface; and the adhesive and the first and second objects have indices of refraction within 0.2.
